(19) United States
(12) Patent Application Publication
(10) Pub. No.: US 2008/0040494 A1
(43) Pub. Date: Feb. 14, 2008

(54) Partitioning a Transmission Control Protocol (TCP) Control Block (TCB)

(76) Inventors: Alok Kumar, Santa Clara, CA (US); Prashant Chandra, Santa Clara, CA (US); Eswar Eduri, Santa Clara, CA (US); Uday Naik, Fremont, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/496,072

(22) Filed: Jul. 28, 2006

(51) Int. Cl. G06F 15/16

(52) U.S. Cl. 709/230

(57) ABSTRACT

Partitioning of a Transmission Control Protocol (TCP) Control Block (TCB) associated with a TCP connection into multiple, independently accessible data structures. A first of the data structures includes TCB data used in handling an egress direction of the TCP connection while a second of the data structures includes TCB data used in handling an ingress direction of the TCP connection.

### REFERENCE TO SOURCE CODE APPENDIX

A source code appendix is included on a CD submitted with this application. The authors retain applicable copyright rights in this material.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately.

A number of network protocols cooperate to handle the complexity of network communication. For example, a protocol known as Transmission Control Protocol (TCP) provides “connection” services that enable remote applications to communicate. That is, much like picking up a telephone and assuming the phone company will make everything in-between work, TCP provides applications with simple primitives for establishing a connection (e.g., CONNECT and CLOSE) and transferring data (e.g., SEND and RECEIVE). Behind the scenes, TCP transparently handles a variety of communication issues such as data retransmission, adapting to network traffic congestion, and so forth.

To provide these services, TCP operates on packets known as segments. Generally, a TCP segment travels across a network within (“encapsulated” by) a larger packet such as an Internet Protocol (IP) datagram. The payload of a segment carries a portion of a stream of data sent across a network. A receiver can restore the original stream of data by collecting the received segments.

Potentially, segments may not arrive at their destination in their proper order, if at all. For example, different segments may travel very different paths across a network. Thus, TCP assigns a sequence number to each data byte transmitted and includes the sequence number of the first payload byte of a segment in the segment header. This enables a receiver to reassemble the bytes in the correct order. Additionally, since every byte is sequenced, each byte can be acknowledged (ACKed) to confirm successful transmission. Thus, a receiver includes an ACK number in an out-bound TCP segment header identifying the next expected sequence number, acknowledging receipt of sequence numbers less than the ACK number.

Transmission Control Protocol (TCP) provides a variety of mechanisms that enable senders and receivers to tailor a connection to the capabilities of the different devices participating in a connection and the underlying network. For example, TCP enables a receiver to specify a receive window that the sender can use to limit the amount of unacknowledged data sent.

Typical implementations store information about a TCP connection in a data structure known as a TCP Control Block (TCB). The TCB stores data used in handling both directions of a TCP connection. For example, the TCB stores the sequence number for the next byte to send (snd_nxt) and the next expected byte to be received (rcv_nxt). The TCB also stores a variety of other state variables.

### BRIEF DESCRIPTION OF THE DRAWINGS

FIG. 1 illustrates use of a Transmission Control Protocol (TCP) Control Block (TCB).

FIG. 2 illustrates multiple, independently accessible partitions of a TCP TCB.

FIG. 3 illustrates use of Transmission Control Protocol (TCP) TCP Control Block (TCB) partitions.

FIG. 4 illustrates input of a TCP segment.

FIG. 5 illustrates output of a TCP segment.

FIGS. 6 and 7 are diagrams of multi-core processors.

### DETAILED DESCRIPTION

Traditionally, TCB data for a flow is stored in a monolithic data structure. Reflecting TCP's bidirectional protocol, this data structure stores data related to both directions of a TCP connection. For example, the TCB stores the next sequence number expected from a remote end-point (rcv_nxt) and the first transmitted sequence number that the remote end-point has not ACKnowledged (snd_una). This traditional implementation, however, can impose constraints that can slow operation of a parallel processing system.

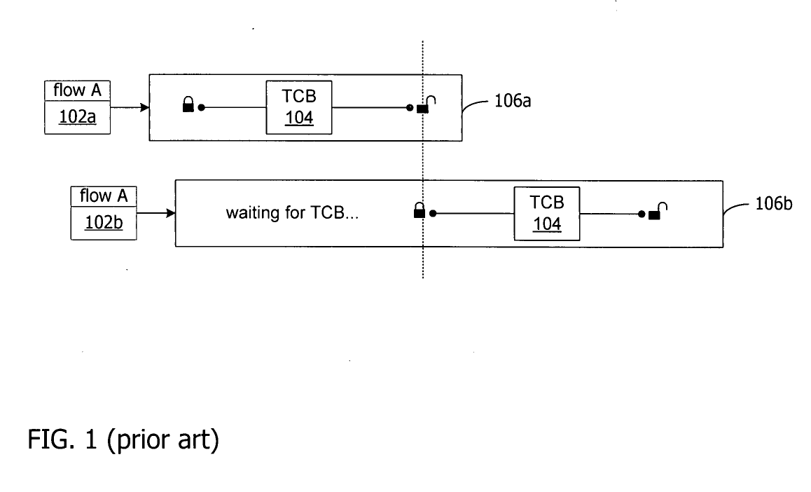

To illustrate, FIG. 1 depicts a system that features multiple programmable cores and/or multiple threads 106a, 106b. In such a system, different cores/threads processing packets belonging to the same flow may try to access the same TCB at the same time. For example, threads 106a, 106b may both attempt to process segments 102a, 120b belonging to flow “A”. As shown, both threads 106a, 106b vie for access to the flow's TCB 104.

A common solution to TCB contention is to protect the TCB 104 with a mutual exclusion lock (mutex)(shown as a padlock). The term mutex is intended to cover a wide variety of mechanisms (e.g., spin locks, deli-tickets, etc) that provide only a single agent with access to a resource. Thus, as shown in FIG. 1, thread 106a acquires the mutex to the TCB 104 for flow “A” and performs a read-modify-write of TCB 104 data. The period when the TCB is locked is known as a critical section of code. After thread 106a releases the mutex, thread 106b can acquire the mutex and begin TCB 104 processing for segment 102b. While the scheme illustrated in FIG. 1 protects coherence of TCB 104 data, the scheme forces thread 106b to wait for TCB access. This delay is particularly problematic when trying to maintain wire-speed processing of data.

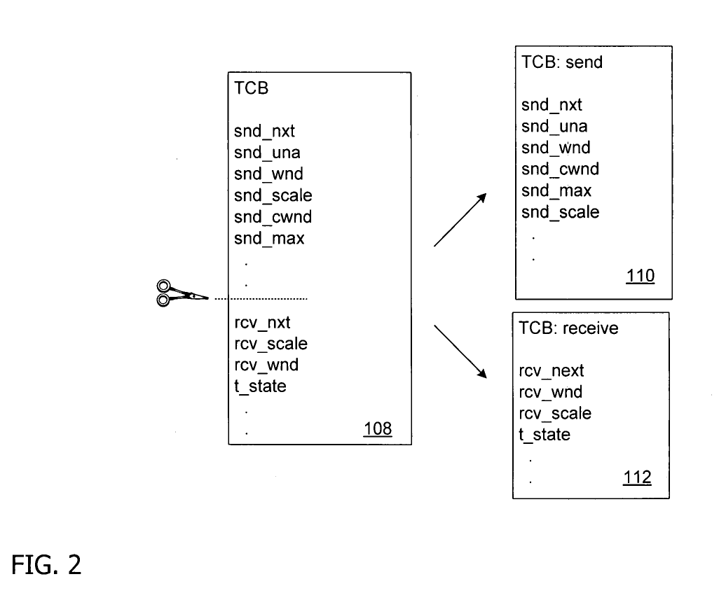

FIG. 2 illustrates a technique that can greatly reduce TCB contention between multiple agents. As shown, instead of a monolithic TCB 108, TCB state variables can be stored in multiple, independently accessible TCB 110, 112 partitions. In the sample implementation shown, TCB data is stored in send 110 and receive 112 partitions.

The TCB send 110 partition includes fields used in handling the egress direction of a bidirectional TCP connection. For example, the send 110 partition includes the next sequence number to use in sending data (snd_nxt), the first unacknowledged sequence number (snd_una), the send window size (snd_wnd), the scale of the send window (snd_scale), the “slow start” congestion window size (snd_cwnd), and the highest sequence number sent (snd_max). A thread handling out-going data will use this TCP data 110, for example, to determine which sequence number to include in an out-bound segment and how much data can be transmitted while staying within the current window limits. A thread preparing a segment for transmission may update the TCB send 110 data, for example, to increase the next sequence number value (snd_nxt) or the maximum sequence number sent (snd_max).

A thread handling a received TCP segment may also use the TCB send 110 partition. For example, an in-coming segment may include data in its ACK field that advances the first unacknowledged sequence number (snd_una). Similarly, an in-coming segment may include a window option that impacts the size of the send window (snd_wnd). Likewise, receipt of a non-duplicate ACK may cause an increase in the congestion window (snd_cwnd).

The TCB receive 112 partition includes fields used in handling the ingress direction of the connection. For example, the receive 112 partition includes the value of the next sequence number expected (rcv_nxt). Upon receipt of an in-order segment, the value of the next sequence number expected (rcv_nxt) may be advanced. Similarly, for out-bound data, the value of the next sequence number expected (rcv_nxt) may be included in the ACK field of an out-bound segment. As shown, the receive 112 partition may also store the TCP state of a connection (t_state) and the size of the receive window (rcv_wnd).

As shown, the state variables included in the different partitions 110, 112 is mutually exclusive. That is, no TCB variable is stored in more than one partition. Additionally, the data structures may represent contiguous memory locations. That is, the send structure 110 and receive structure 112 may each be composed of state variables occupying contiguous memory locations. The structures themselves, however, may not be contiguous. That is, send structure 110 and receive structure 112 may be separated by memory locations.

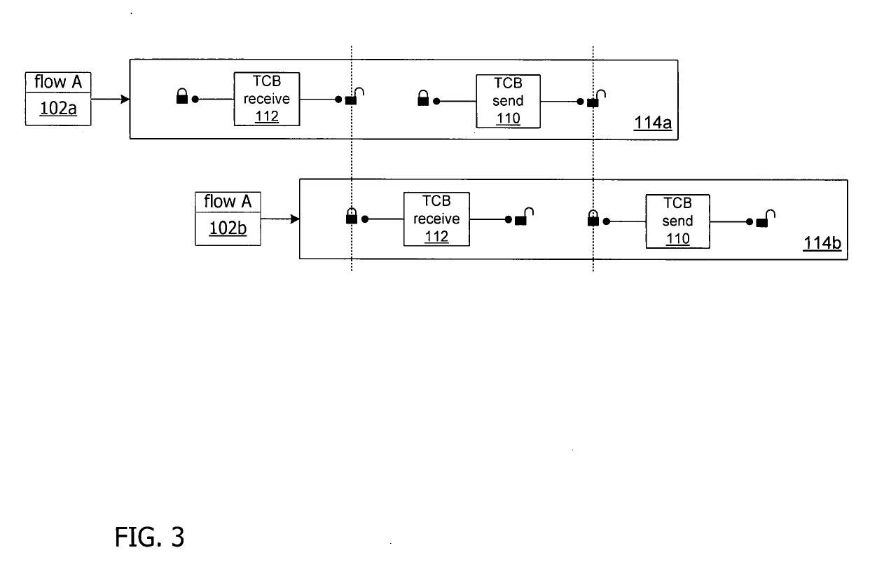

As shown in FIG. 3, dividing a TCB into multiple partitions can reduce the amount of processing delay cause by TCB contention. For example, the send 110 and receive 110 partitions may be protected by different mutexes. Thus, as shown, access to the send 110 partition (e.g., for packet 102a) and the receive partition 110 data (e.g., for packet 102b) can occur simultaneously. For example, a thread 114a handling receipt of a received TCP segment 102b and a thread 114b handling transmission of an out-bound TCP segment 102b can both access data of the same flow's TCB at the same time. Additionally, if TCB partition contention does occur, instead of a potentially lengthy period of time where an entire TCB is exclusively locked, a thread may make briefer access to the smaller TCB partitions 110, 112 shortening the period where one thread is stalled waiting for TCB access.

FIG. 2 described only a few of the data fields included in the TCB receive 112 and send 110 partitions. Appendix A includes a complete source code listing of these data structures. The source code listed in Appendix A is, merely an example, and many other implementations are possible. For example, while FIGS. 2 and 3 described dividing a TCB into two partitions, as shown in Appendix A, a TCB can be divided into many independently accessible partitions. For example, as shown, the TCB may divided into four partitions: a sender “critical” data structure, a sender “non-critical” data structure, a receiver “critical” data structure, and a receiver “non-critical” data structure. The non-critical data structures may store less frequently accessed data such as data used to perform segment reassembly, handling of a segment flagged as urgent, and so forth. While “non-critical” data is mutex protected, the “non-critical” (e.g., less frequently accessed) data structures may be stored in slower memory such as DRAM (Dynamic Random Access Memory) while the critical structures data structures are stored in a comparatively faster memory such as SRAM (Static Random Access Memory).

The different data structures may be organized as one or more arrays of data structures. An index into the array can be computed from a TCP/IP tuple (e.g., a hashing of a TCP/IP packet's IP source and destination addresses, TCP source and destination ports, and the transfer protocol). This index can be used to lookup the partition of interest. For example, an implementation may feature four parallel arrays for each of the critical and non-critical partitions with like indexed array structures representing the partition for a particular flow.

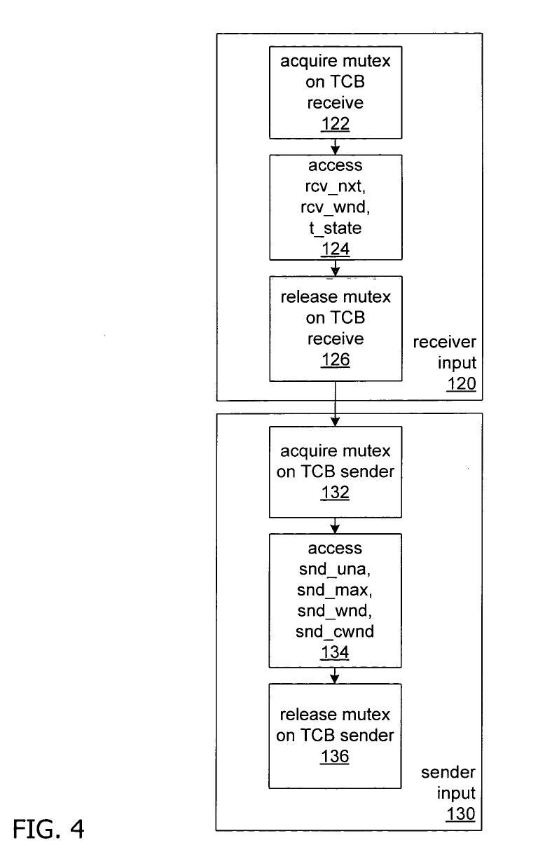

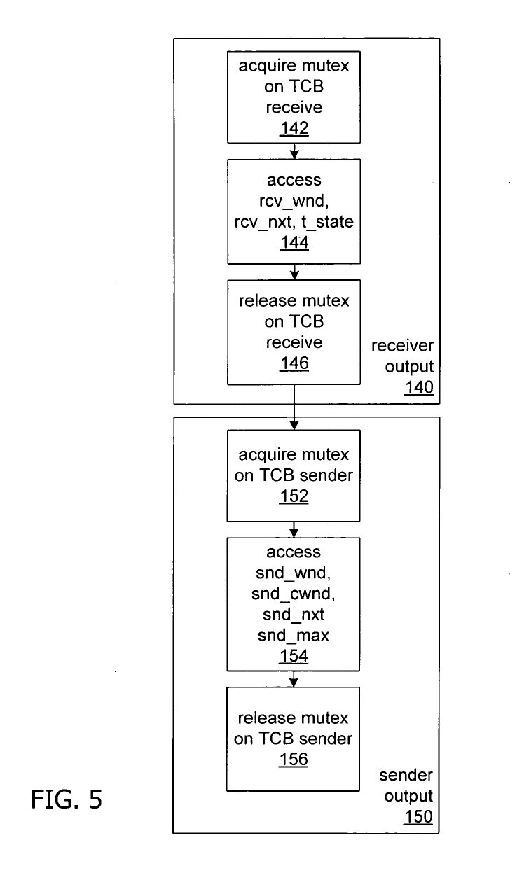

The “split” TCB technique may be used in a variety of TCP implementations. For example, FIGS. 4 and 5 illustrate an implementation that features receiver and sender functions. Since every TCP segment has information pertaining to both directions of a connection, the receiver and sender functions both include functions to process in-coming and out-bound data. More specifically, the receiver function features an input function 120 to handle in-coming segments and an output function 140 to handle out-bound data. Similarly, the sender function includes an input 130 and output 150 function. As shown in FIG. 4, to process a received segment the input functions 120, 130 of the receiver and sender functions are invoked. Likewise, as shown in FIG. 5, to process out-bound data the output functions 140, 150 of the receiver and sender functions are invoked.

The implementations shown in FIGS. 4 and 5 constrain access to TCB partitions within the respective input and output functions. That is, each of the input 120, 130 and output 140, 150 functions exclusively access one of the TCB receive or send partitions. This enables the input and output functions to operate independently. For example, the input function 120 of the receiver function accesses the TCB receive partition but does not prevent simultaneous access of the TCB sender partition by the sender input 130 or output 150 functions.

As shown in FIGS. 4 and 5, before accessing a particular partition, a function may acquire a mutex 122, 132, 142, 152 protecting the data structure from being simultaneously modified by multiple agents and release the mutex 126, 136, 146, 156 after completing access.

In greater detail, FIG. 4 illustrates processing of a received segment by the receiver input 120 and sender input 130 functions. The receiver input function 120 accesses state variables in the TCP receive partition 124. For example, the function 120 can access the receive next value (rcv_nxt) variable to determine how much of the data received in the segment overlaps previously received data and can also advance the receive next value (rcv_nxt) to reflect data received in the segment. The function 120 can access other state variables, for example, to update the receive window (rcv_wnd) or update the TCP state (t_state) of a connection.

The sender input function 130 can respond to information included in the received segment such as the ACK sequence number. As shown, the function 130 can access state variables in the send partition, for example, to update the next unacknowledged byte value (snd_una) and adjust the send window (snd_wnd) and send congestion window (snd_cwnd). The function 130 may also access the value of the maximum sequence number sent (snd_max) to determine if the remote end-point has received all transmitted bytes.

Though the receiver 120 and sender input 130 functions illustrated each exclusively access their own receive and send TCB partitions, the functions may share some state variable information in a read-only fashion. For example, the receiver input 120 function may build a message to the sender input 130 function that includes, for example, the TCP state. The sender input 130 function can access this value, but cannot change the underlying, coherent value in the TCB receive partition.

FIG. 5 illustrates handling of out-bound TCB data by the receiver output 140 and sender output 150 functions. As shown, the receiver output function 140 can access state variables in the receive TCB partition(s), for example, to update the TCB state (t_state) or access data to include in the out-going TCP segment (e.g., rcv_nxt and rcv_wnd). Similarly, the sender output function 150 can access state variables in the send TCB partition(s), for example, to make sure data is not sent in excess of the send window (snd_wnd) (as adjusted by the send scale (snd_scale)) or in excess of the congestion window (snd_cwnd). Potentially, the function 150 may update the send next (snd_nxt) or send maximum (snd_max) values based on the amount of data transmitted within the out-bound segment.

Appendix B includes a listing of source code to implement functions described above. The source code assumes use of a compiler (e.g., the Intel® IXP-C compiler) that automatically inserts mutex handling instructions into executable code that features data structures commonly accessed by different processing agents. While the source code listing and FIGS. 4 and 5 illustrated a specific software architecture for implementing access to the TCB partitions, a wide variety of other architectures may implement techniques described above.

The technique of partitioning data used in handling data transmission and receipt can also be applied in other areas. For example, typically a TCP/IP socket has an associated data structure that includes data used in both data transmission and receipt. For instance, a socket typically monitors send and receive buffers used to store in-coming and out-going data. As an example, a socket data structure can store the amount of data stored in the send buffer, the maximum amount of data stored in the send buffer, the amount of data stored in the receive buffer, and the maximum amount of data stored in the receiver buffer. Partitioning a socket data structure into multiple, independently accessible data structures can enhance a system's ability to process incoming and out-going data for the same bi-directional socket in parallel. For example, data related to the send buffer can be stored in a send socket data structure while data related to the receive buffer can be stored in receive socket data structure. Thus, a given socket can potentially process both in-coming data and out-going data in parallel.

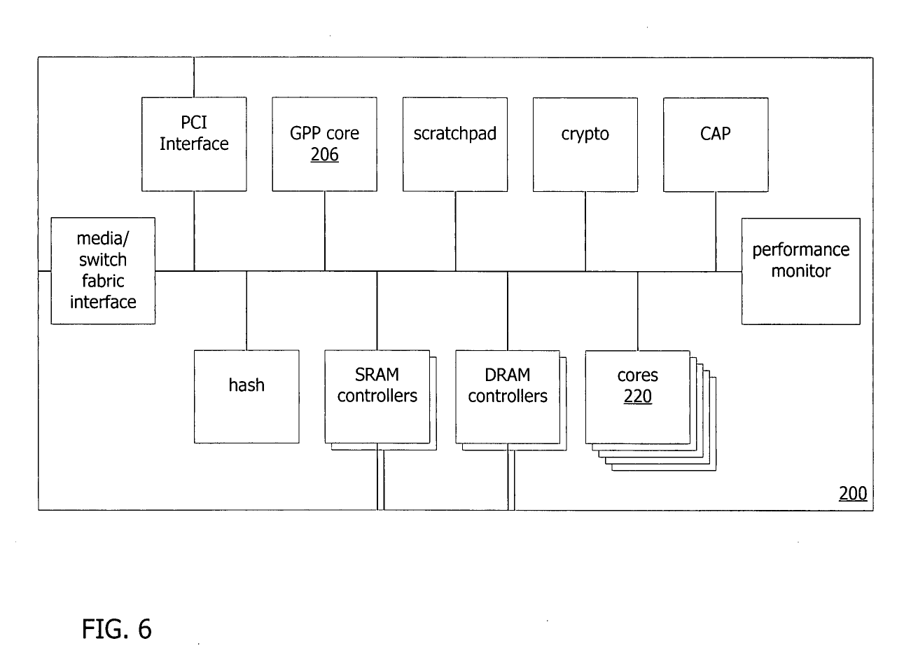

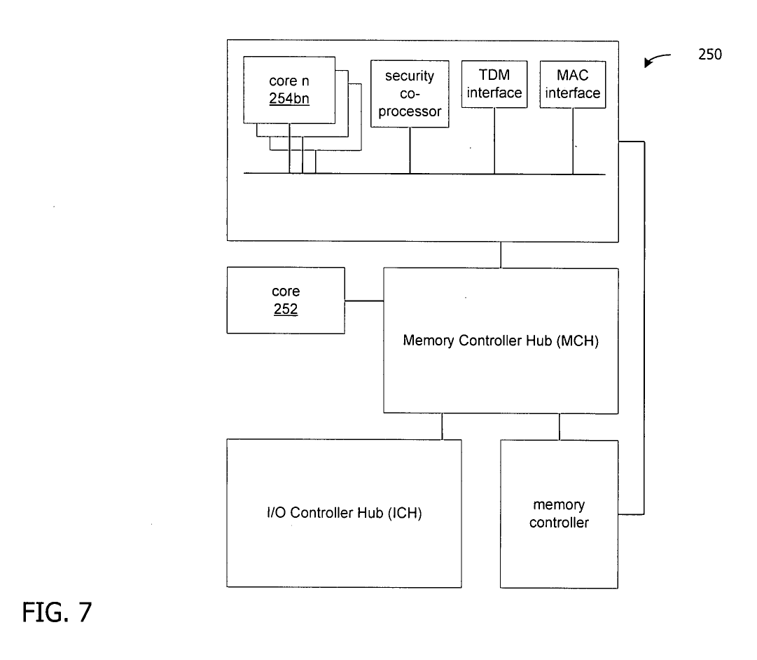

The techniques describe above can be implemented in a variety of environments. For example, the techniques may be implemented with a network processor. As an example, FIG. 6 depicts an example of a network processor 200 that can be programmed to process packets. The network processor 200 shown is an Intel® Internet eXchange network Processor (IXP). Other processors feature different designs. The network processor 200 shown features a collection of programmable processing cores 220, 206 (e.g., programmable engines) on a single integrated semiconductor die. Core 220 may be a Reduced Instruction Set Computer (RISC) processor tailored for packet processing. For example, the cores 220 may not provide floating point or integer division instructions commonly provided by the instruction sets of general purpose processors. Individual cores 220 may provide multiple threads of execution. For example, a core 220 may store multiple program counters and other context data for different threads. FIG. 7 depicts another multi-core processor 250 that features multiple cores 254, 252 that share a memory controller hub, I/O controller hub (e.g., PCI interface), and memory controller. Both processors 200, 250 may be coupled to or include an integrated media access controller (MAC) and memory to send and receive data from a network connection.

In both processors 200, 250, TCP processing may be offloaded to one or more of the cores. That is, multiple threads of the cores may perform TCP termination. The techniques described above can greatly speed the threads ability to process TCP segments by supporting greater parallel operation.

While FIGS. 6 and 7 described specific examples of processors, the techniques may be implemented in a variety of architectures having designs other than those shown. For example, techniques described above can also be implemented in a wide variety of circuitry (e.g., ASICs (Application Specific Integrated Circuits), PGA (Programmable Gate Arrays), and so forth). The term circuitry as used herein includes digital circuitry and analog circuitry. The circuitry design may be generated by encoding logic described above in a hardware description language (e.g., Verilog or VHDL). The circuitry may also include programmable circuitry. The programmable circuitry may include a processor that operates on computer programs, disposed on computer readable storage mediums.

Other embodiments are within the scope of the following claims.

### Appendix A: Sample Partitions

typedef struct tcb_receiver_s
{

| uint32_t | t_flags: 15, | |
|---|---|---|
| | reassembly_exists:1, | /* boolean indicates reassembly exists */ |
| | rcv_scale:8, | /* window scaling for recv window */ |
| | t_state:8; | /* state of this connection */ |
| #define | TF_NODELAY 0x0004 | /* don't delay packets to coalesce */ |
| #define | TF_ACKNOW 0x0010 | /* ack peer immediately */ |

| #define | TF_RCVD_SCALE | 0x0040 /* other side has requested scaling */ |
|---|---|---|
| #define | TF_RCVD_TSTMP | 0x0100 /* a timestamp was received in SYN */ |
| #define | TF_SACK_PERMIT | 0x0200 /* other side said I could SACK */ |
| /* receive sequence variables */ | | |
| uint32_t | rcv_wnd; | /* receive window */ |
| uint32_t | rcv_nxt; | /* receive next */ |
| uint32_t | ipv4_id:16, | /* used to calculate ipv4_id field for outgoing |

packets */

| | |
|---|---|
| t_maxseg:16; | /* Maximum segment in bytes to be sent in this |

connection */
} tcb_receiver; // total usable = 16B
typedef struct tcb_receiver_non_critical_s
{

| | | |
|---|---|---|
| uint32_t | rcv_up; | /* receive urgent pointer */ |
| uint32_t | irs; | /* initial receive sequence number */ |
| uint32_t | iss; | /* initial send sequence number */ |

| | |
|---|---|
| /* out-of-band data */ | // -- used for urgent pointer |

| | | |
|---|---|---|
| uint32_t | t_oobflags:8, | /* have some */ |

| | |
|---|---|
| t_iobc:8, | /* input character */ |

| | |
|---|---|
| t_softerror:8, | /* possible error not yet reported */ |

| | request_r_scale:8; | |
|---|---|---|
| #define | TCPOOB_HAVEDATA | 0x01 |
| #define | TCPOOB_HADDATA | 0x02 |

| /* Reassembly data structure */ | |
|---|---|
| dl_buf_handle_t | reassembly_head; |
| uint32_t | pad; |

} tcb_receiver_non_critical; // total = 24B
typedef struct tcb_sender
{

| uint32_t | t_flags:10, | /* tcp sender flags */ |
|---|---|---|
| | t_idle:22; | /* inactivity time */ |
| #define | TF_NOOPT 0x0001 | /* don't use tcp options */ |
| #define | TF_SENTFIN 0x0002 | /* have sent FIN */ |
| #define | TF_REQ_SCALE 0x0004 | /* have/will request window scaling */ |
| #define | TF_REQ_TSTMP 0x0008 | /* have/will request timestamps */ |

| // TF_ACKNOW is already defined to 0x0010 in tcp_receiver.h | | |
|---|---|---|
| #define | TF_KEEP_TIMER | 0x0020 |
| #define | TF_PERSIST_TIMER | 0x0040 |
| #define | TF_REXMT_TIMER | 0x0080 |
| #define | TF_MSL_TIMER | 0x0100 |

| | | |
|---|---|---|
| #define | TF_DELACK 0x0200 | /* ack, but try to delay it */ |

| /* send sequence variables */ | | |
|---|---|---|
| uint32_t | snd_una; | /* send unacknowledged */ |
| uint32_t | snd_scale:8, | /* window scaling for send window */ |

| | |
|---|---|
| snd_wnd:24; | /* send window */ |

| uint32_t | snd_nxt; | |
|---|---|---|
| /* retransmit variables */ | | |
| uint32_t | snd_max; | /* highest sequence number sent; |

* used to recognize retransmits
*/

/* congestion control (for slow start, source quench, retransmit after loss)

*/

| | | |
|---|---|---|
| uint32_t | exceptions:3, | /* bitmask indicating whether values are non- |

zero */

pad: 13,
snd_cwnd_factor:16; /* congestion-controlled window --

multiplication factor of t_maxseg */

| | | |
|---|---|---|
| #define | EX_T_RXTSHIFT | 0x01 /* t_rxtshift field is non-zero in |

non_critical struct */

| | | |
|---|---|---|
| #define EX_T_SOFTERROR | 0x02 | /* t_softerror field is non-zero in |

non_critical struct */

| | | |
|---|---|---|
| #define EX_T_RTT | 0x04 | /* t_rtt field is zero in non_critical struct |

*/

| /* | | |
|---|---|---|
| * transmit timing stuff. See below for scale of srtt and rttvar. | | |
| * “Variance” is actually smoothed difference. | | |
| */ | | |
| uint32_t | t_rxtcur:16, | /* cur retxt val */ |
| | t_srtt:16; | /* smoothed round-trip time */ |
| uint32_t | t_rttvar:16, | /* variance in round-trip time */ |
| | t_rttmin:16; | /* minimum rtt allowed */ |
| uint32_t | last_ack_sent; | |
| uint32_t | ts_recent; | /* timestamp echo data */ |
| uint32_t | ts_recent_age; | /* when last updated */ |
| uint32_t | rcv_adv; | /* advertised window */ |
| uint32_t | sndBufSize; | /* amount of data in send buffer */ |

| | |
|---|---|
| uint32_t | pad1; |

| | |
|---|---|
| } tcb_sender; | // total usable = 48B |

typedef struct tcb_sender_non_critical_s
{

| uint32_t | t_rxtshift:16, | /* log(2) of rexmt exp. backoff */ |
|---|---|---|
| | t_dupacks:16; | /* consecutive dup acks recd */ |
| uint32_t | snd_up; | /* send urgent pointer */ |
| uint32_t | snd_w11; | /* window update seg seq number */ |
| uint32_t | snd_w12; | /* window update seg ack number */ |

| | |
|---|---|
| uint32_t | snd_ssthresh_factor:16,/* snd_cwnd_factor size threshhold for |

```
* for slow start exponential to
  * linear switch
  */
```

snd_cwnd_linear_growth_count:16; /* Count of number of acks

received for cwnd linear growth */

| uint32_t | t_rtt:16, | |
|---|---|---|
| | requested_s_scale:8, | /* pending window scaling */ |
| | t_softerror:8; | /* softerror field */ |
| uint32_t | t_rtseq; | /* sequence number being timed */ |
| uint32_t | max_sndwnd; | /* largest window peer has offered */ |

} tcb_sender_non_critical; // total = 32B

What is claimed is:

1. A method of processing Transmission Control Protocol (TCP) segments belonging to a bidirectional TCP connection, the method comprising:
(a) to transmit to a TCP connection end-point:
accessing a first independently accessible and contiguous data structure associated with the TCP connection, the first data structure including TCP Control Block (TCB) data used in handling an egress direction of the bidirectional TCP connection, the data including identification of the next TCP segment sequence number to send;
modifying the next TCP segment sequence number to send;
accessing a second, independently accessible and contiguous data structure, the second data structure including TCP Control Block (TCB) data used in handling an ingress direction of the bidirectional TCP connection, the data including identification of the next expected TCP segment sequence number to receive; and
including the next expected TCP segment sequence number in a TCP segment transmitted to the TCP connection end-point; and
(b) to receive data from a TCP connection end-point;
accessing the first data structure, the first data structure also storing data identifying the first unacknowledged TCP segment sequence number transmitted;
modifying the last acknowledged TCP segment sequence number based on the received data;
accessing the second, independently accessible data structure; and
modifying the next expected TCP segment sequence number to receive based on the received data.

2. The method of claim 1,
wherein transmitting data to the TCP connection end-point occurs at a first thread; and
wherein receiving data from the TCP connection end-point occurs at a second thread.

3. The method of claim 1,
wherein the receiving data from the TCP connection end-point occurs at a first programmable processing unit integrated on a die; and
wherein the transmitting data to the TCP connection end-point occurs at a second programmable processing unit integrated on the same die.

4. The method of claim 1, further comprising looking up the first data structure and the second data structure based, at least, on an Internet Protocol address of a first connection end-point, an Internet Protocol address of a second connection end-point, the port of the first connection end-point, and the port of the second connection end-point.

5. The method of claim 1,
wherein
a first mutex is associated with the first data structure; and
a second mutex is associated with the second data structure; and
further comprising:
acquiring the first mutex before accessing the first data structure; and
acquiring the second mutex before accessing the second data structure.

6. The method of claim 1, further comprising:
accessing a third independently accessible data structure including data used in handling data being transmitted via a socket; and
accessing a independently accessible fourth data structure including data used in handling data being received via the socket.

7. The method of claim 1, wherein the TCB data stored in the first and second data structures is mutually exclusive.

8. The method of claim 7,
wherein the first data structure comprises a data structure to store, at least, the following variables: rcv_wnd (receive window), rcv_nxt (receive next), and rcv_scale (receive scale); and
wherein the second data structure comprises a data structure to store, at least, the following variables: snd_una (send unacknowledged), snd_wnd (send window), and snd_scale (send scale).

9. The method of claim 1, further comprising storing partitions of TCB data for a flow in memories offering different latencies.

10. A computer program, disposed on a computer readable storage medium of processing Transmission Control Protocol (TCP) segments belonging to a bidirectional TCP connection, the program comprising instructions for causing at least one processor:
(a) to transmit to a TCP connection end-point by:
accessing a first independently accessible and contiguous data structure associated with the TCP connection, the first data structure including TCP Control Block (TCB) data used in handling an egress direction of the bidirectional TCP connection, the data including identification of the next TCP segment sequence number to send;
modifying the next TCP segment sequence number to send;
accessing a second, independently accessible and contiguous data structure, the second data structure including TCP Control Block (TCB) data used in handling an ingress direction of the bidirectional TCP connection, the data including identification of the next expected TCP segment sequence number to receive; and
including the next expected TCP segment sequence number in a TCP segment transmitted to the TCP connection end-point; and
(b) to receive data from a TCP connection end-point by:
accessing the first data structure, the first data structure also storing data identifying the first unacknowledged TCP segment sequence number transmitted;
modifying the last acknowledged TCP segment sequence number based on the received data
accessing the second, independently accessible data structure; and
modifying the next expected TCP segment sequence number to receive based on the received data.

11. The computer program of claim 10, further comprising instructions for causing the at least one processor to look up the first data structure and the second data structure based, at least, on an Internet Protocol address of a first connection end-point, an Internet Protocol address of a second connection end-point, the port of the first connection end-point, and the port of the second connection end-point.

12. The computer program of claim 10,
wherein
a first mutex is associated with the first data structure; and
a second mutex is associated with the second data structure; and
further comprising instructions for causing the at least one processor to:
acquire the first mutex before accessing the first data structure; and
acquire the second mutex before accessing the second data structure.

13. The computer program of claim 10, further comprising instructions for causing the at least one processor to:
access a third independently accessible data structure including data used in handling data being transmitted via a socket; and
access a independently accessible fourth data structure including data used in handling data being received via the socket.

14. The computer program of claim 10, wherein the TCB data stored in the first and second data structures is mutually exclusive.

15. The computer program of claim 14,
wherein the first data structure comprises a data structure to store, at least, the following variables: rcv_wnd (receive window), rcv_nxt (receive next), and rcv_scale (receive scale); and
wherein the second data structure comprises a data structure to store, at least, the following variables: snd_una (send unacknowledged), snd_wnd (send window), and snd_scale (send scale).

16. A system, comprising:
at least one media access controller;
memory; and
multiple programmable cores integrated on a single die;
wherein at least one of the multiple processor cores is programmed to process Transmission Control Protocol (TCP) segments belonging to a bidirectional TCP connection, the processing including:
(a) transmitting to a TCP connection end-point by:
acquiring a first mutex associated with a first independently accessible and contiguous data structure associated with the TCP connection, the first data structure including TCP Control Block (TCB) data used in handling an egress direction of the bidirectional TCP connection, the data including identification of the next TCP segment sequence number to send;
accessing the first independently accessible and contiguous data structure associated with the TCP connection;
modifying the next TCP segment sequence number to send;
releasing the first mutex;
acquiring a second mutex associated with a second, independently accessible and contiguous data structure, the second data structure including TCP Control Block (TCB) data used in handling an ingress direction of the bidirectional TCP connection, the data including identification of the next expected TCP segment sequence number to receive;
accessing the second data structure;
including the next expected TCP segment sequence number in a TCP segment transmitted to the TCP connection end-point;
releasing the second mutex; and
(b) receiving data from a TCP connection end-point by:
acquiring the first mutex;
accessing the first data structure, the first data structure also storing data identifying the first unacknowledged TCP segment sequence number transmitted;
modifying the last acknowledged TCP segment sequence number based on the received data releasing the first mutex;
acquiring the second mutex;
accessing the second, independently accessible data structure; and
modifying the next expected TCP segment sequence number to receive based on the received data; and
releasing the second mutex.

17. The system of claim 16, wherein the TCB data stored in the first and second data structures is mutually exclusive.

18. The system of claim 16,
wherein the first data structure comprises a data structure to store, at least, the following variables: rcv_wnd (receive window), rcv_nxt (receive next), and rcv_scale (receive scale); and
wherein the second data structure comprises a data structure to store, at least, the following variables: snd_una (send unacknowledged), snd_wnd (send window), and snd_scale (send scale).

19. A computer program, stored on a computer readable storage medium, comprising instructions for causing a processor to:
store and access data of a Transmission Control Protocol (TCP) Control Block (TCB) in at least two independently accessible data structures, wherein a first of the at least two independently accessible data structures includes, at least, a first set of variables that includes a TCP receive window variable, a TCP receive next variable, and a TCP receive scale variable, and wherein a second of the at least two independently accessible data structures includes, at least, a second set of variables that includes a TCP send unacknowledged variable, a TCP send window variable, and a TCP send scale variable; and wherein the first set of variables and the second set of variables store mutually exclusive sets of variables.

20. The computer program of claim 19, wherein the first and second data structures are stored non-contiguously with respect to one another in memory.

21. The computer program of claim 19, wherein the first data structure and second data structure are protected by different mutexes.
